(19) United States
(12) Patent Application Publication
(10) Pub. No.: US 2023/0160706 A1
(43) Pub. Date: May 25, 2023

(54) HEURISTIC METHOD FOR OPTIMIZING OR IMPROVING UTILIZATION IN VEHICLE FLEET MANAGEMENT

(71) Applicant: AT&T Intellectual Property I, L.P., Atlanta, GA (US)

(72) Inventors: Rudolph L. Mappus, IV, Plano, TX (US); Debashish Bhattacharjee, Burleson, TX (US); Shane McCord, Wylie, TX (US)

(73) Assignee: AT&T Intellectual Property I, L.P., Atlanta, GA (US)

(21) Appl. No.: 17/533,692

(22) Filed: Nov. 23, 2021

(51) Int. Cl. G01C 21/34

(52) U.S. Cl. CPC G01C 21/3469; G01C 21/3461; G01C 21/3492

(57) ABSTRACT

Aspects of the subject disclosure may include, for example, generating a graph having nodes corresponding to garages, and edges corresponding to distances between pairs of garages that store moveable assets. A complexity of the graph in terms of nodes and/or edges is reduced, e.g., by segmenting the graph into sub-graphs, to obtain a modified graph. For each sub-graph, utilization values of the moveable assets are estimated for each node and metrics are calculated as pairwise differences between estimated utilizations less twice the distance between the corresponding garages. Candidate node pairs are identified as having metric values greater than zero. Node assets are ordered according to utilizations and a transfer recommendation is identified according to a garage pair having a maximum metric and an asset pair utilization having maximum difference. Other embodiments are disclosed.

### FIELD OF THE DISCLOSURE

The subject disclosure relates to a heuristic method for optimizing or improving utilization in vehicle fleet management.

### BACKGROUND

A collection of assets may include moveable equipment, such as vehicles and/or tools. The assets may serve one or more purposes, sometimes referred to as jobs, such as a transfer of goods and/or people, logistics support and/or other services. In at least some applications the assets may be used for field work as may be encountered during construction and/or maintenance activities. Collections of moveable assets, sometimes referred to as fleets, may be simple, e.g., including a single type of asset, or complex, e.g., including multiple types of assets. It is not unusual for firms to invest significant resources into the acquisition and management of their fleets in the interests of business efficiency. Generally speaking, management of collections of mobile assets encompasses management of lifecycles for each asset member, e.g., each vehicle of a fleet. Lifecycle events may include one or more of a purchase, sale, maintenance, and/or placement, e.g., storage or garaging, decisions of fleet resources.

Fleet management strategies may include maximizing a lifespan and/or a present value of a fleet. Efficient management of fleets, however, may pose a complicated endeavor, even for fleets as small as a few vehicles. For example, decisions encountered during a lifecycle management of each fleet member, may also affect the overall fleet costs and/or value. By way of example, at least one consideration in determining a fleet's value may include observations of each fleet member's utilization. To the extent assets, such as vehicles and/or tools, are viewed as resources for completing work, utilization may include distances traveled and/or operating hours. Consider overused vehicles as representing an over-consumed resource, e.g., losing value, while underused vehicles represent value by not being utilized. Thus, an optimal consumption strategy of fleet resources would maximize their value by inhibiting usage of overused assets, while promoting usage of underused assets.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of an asset management system functioning within the communication network of FIG. 1 in accordance with various aspects described herein.

FIG. 2B is a block diagram illustrating an example, non-limiting embodiment of a heuristic-modified graphical representation of the graph of FIG. 2B and the asset management system of FIG. 2A in accordance with various aspects described herein.

FIG. 2C is a graphical representation of an example, non-limiting embodiment of a system functioning within the communication network of FIG. 1 in accordance with various aspects described herein.

FIG. 2D is a block diagram illustrating an example, non-limiting embodiment of a graphical representation of the asset management system of FIG. 2A in accordance with various aspects described herein.

FIG. 2E is a graphical representation of an example application of a non-limiting embodiment of a system functioning within the communication network of FIG. 1 and according to the graphical representation of the asset management system of FIG. 2A, in accordance with various aspects described herein.

FIG. 2F depicts an illustrative embodiment of a mobile asset management process in accordance with various aspects described herein.

FIG. 2G depicts an illustrative embodiment of another mobile asset management process in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for applying a heuristic process to simplify a graph of geographically dispersed storage facilities adapted to house members of a fleet. A graph is generated having nodes corresponding to storage facilities, and edges corresponding to transfer costs, e.g., distances, between pairs of storage facilities. A complexity of the graph in terms of nodes and/or edges may be reduced, e.g., by removing node(s), edge(s), and/or segmenting the graph into two or more sub-graphs. Utilization values of the moveable assets may be estimated for each node and metrics may be calculated for each sub-graph as pairwise differences between estimated utilizations less twice the distance between the corresponding storage facilities. Candidate node pairs may be identified as having metric values greater than zero. Node assets may be ordered according to utilizations and a transfer recommendation may be identified according to a storage facility pair having a maximum metric and an asset pair utilization having maximum difference. Other embodiments are described in the subject disclosure.

One or more aspects of the subject disclosure include a process, which includes generating, by a processing system including a processor, a graph. The graph includes multiple nodes corresponding to garage facilities and edges joining interconnected node pairs of the multiple nodes. The edges correspond to inter-garage distances between the interconnected node pairs. The interconnected node pairs are reduced to obtain a simplified graph. A number of vehicle tour lengths are predicted that correspond to the multiple nodes, whereby a tour length of the number of vehicle tour lengths is obtained during an event in which a vehicle of a fleet of vehicles travels from, and returns to, one of the garage facilities. For each of the interconnected node pairs of the simplified graph, differences in vehicle tour lengths less respective round-trip distances of the inter-garage distances are calculated to obtain interconnected node comparison values. A candidate interconnected node pair is selected according to the interconnected node comparison values, and a recommendation is made for transferring a recommended pair of vehicles of the fleet. A transfer of the recommended pair of vehicles facilitates lifecycle management of the fleet of vehicles, e.g., by tending to equalize utilization across fleet members.

One or more aspects of the subject disclosure include a system, having a processing system including a processor, and a memory that stores executable instructions. The instructions, when executed by the processing system, facilitate performance of operations that include generating a graph including a number of nodes corresponding to mobile asset storage locations and edges joining interconnected node pairs of the number of nodes. The edges correspond to transfer costs of mobile assets between the interconnected node pairs. The graph is simplified to obtain a simplified graph having a reduced number of interconnected pairs of the number of nodes. Asset utilization values are predicted corresponding to the number of nodes. A difference in respective predicted asset utilization values is calculated for each of the interconnected node pairs, less a respective mobile asset transfer cost to obtain interconnected node comparison values. A candidate interconnected node pair is identified according to the interconnected node comparison values, and transfer of a pair of mobile assets is recommended between the candidate interconnected node pair to obtain a recommended pair of mobile assets. A transfer of the recommended pair of mobile assets facilitates lifecycle management of the plurality of mobile assets, e.g., by tending to equalize utilization across fleet members.

One or more aspects of the subject disclosure include a machine-readable medium, comprising executable instructions that, when executed by a processing system including a processor, facilitate performance of operations. The operations include generating a graph including nodes corresponding to asset storage locations and edges joining a number of interconnected node pairs of the nodes. The edges correspond to transfer costs of an asset between the interconnected node pairs. The graph includes a complexity according to one of a number of the nodes, a number of the edges, or both. The complexity of the graph is reduced to obtain a modified graph and estimates are obtained for asset utilization values corresponding to nodes. For each of the number of interconnected node pairs of the modified graph, a difference is calculated in respective asset utilization values less a respective asset transfer cost of the asset to obtain interconnected node comparison values. A candidate interconnected node pair is identified according to the interconnected node comparison values, and a transfer of a pair of assets is initiated between the candidate interconnected node pair to obtain a recommended pair of assets. The transfer of the recommended pair of assets facilitates lifecycle management of the plurality of assets, e.g., by tending to equalize utilization across fleet members.

Vehicle utilization across a fleet may be managed so as to improve, enhance and/or otherwise maximize a value of the fleet. For example, decisions that affect a vehicle's location and/or selection for jobs may affect the vehicle's utilization. It is generally understood that a vehicle's value decreases with usage. Accordingly, vehicles that tend to have higher utilizations will generally have lower valuations. In at least some instances, a fleet's valuation may be obtained according to a sum of the individual vehicle valuations across the fleet. In at least some scenarios, a vehicle's valuation does not decrease in a linear manner with respect to utilization. For example, an amount of decrease in valuation for each unit of utilization may increase, such that a decrease in value for a first mile driven, may be less than a decrease in value for the last mile driven. Such valuation-versus-utility relationships may be referred to as convex.

In at least some scenarios, a fleet's value may be increased by managing a utilization of fleet members in such a manner so as to equalize utilization across the fleet. Accordingly, if one vehicle has a relatively high utilization and another vehicle has a relatively low utilization, the latter vehicle should be selected for the next job, assuming both vehicles are adapted for similar jobs. If both vehicles are housed at a common facility, e.g., a garage, then the lower-utilized vehicle may be selected for the next job, such that an increase in utility resulting from that job will tend to equalize utilization between the vehicles, e.g., reducing a relative utilization difference. If future selections of vehicles are made in a like manner, it is envisioned that at some point, a utilization of the formerly lower-utilized vehicle may surpass a utilization of the formerly higher-utilized vehicle. To the extent this occurs, the formerly higher-utilized vehicle could be selected for the next job, once again, trending towards a balanced utilization.

It is expected that each vehicle's utilization will increase over time as a it is used for its intended purpose. However, any particular rate and/or variation in utilization may depend on one or more factors, such as a volume and/or rate of jobs to which the vehicle may be applied, a job type, a job length, a location of the job and/or the vehicle, and so on. It is also understood that periods of usage may be interspersed with periods of non-usage and/or restorative maintenance. Implementation of a fleet-member utilization plan, such as the preceding balancing utilization example may be complicated by the vehicles being positioned at different geographic locations. Consequently, although it may be beneficial to select a relatively low-used vehicle at garage B for one job over a relatively high-used vehicle at garage A, a distance between garages A and B may render such a choice impractical.

To the extent utilization of fleet members across a fleet may be managed, a management plan may be implemented to improve, and in at least some instances, to optimize a value of the fleet. For example, improving vehicle utilization for all vehicles in the fleet, e.g., balancing such utilization, would tend to improve, increase and, in at least some instances, optimize valuation of the fleet. Managing, e.g., improving or optimizing, fleet utilization can be thought of as a resource allocation problem, in which a given volume of jobs are to be completed by a set group of vehicles. A number of jobs done may be maximized, e.g., completing all requested jobs, in such a manner that substantially balances utilization of the group of vehicles applied to those jobs. Such a balanced utilization of all vehicles in a fleet, would tend to realize a value of the vehicle resources as quickly as possible. Additionally, as vehicle value depreciates according to age and/or increased usage, a fleet management objective may be applied to realize the value of each vehicle as quickly as possible, and therefore utilize each vehicle as equally as possible for the services it provides.

It is understood that in at least some embodiments adapted to increase fleet valuations by managing utilization of fleet members, the results may not be optimal. For example, a managed utilization that results in repositioning of fleet members among geographically dispersed locations may be employed periodically, e.g., during anticipated periods of reduced jobs, so as not to interfere with servicing any requested job. Alternatively or in addition, a repositioning of fleet members may be implemented according to a strategy that tends to swap those fleet members at different geographic locations having a relatively large, and in at least some instances, greatest difference in utilization. Namely, a least utilized vehicle at one location may be swapped with another highest utilized vehicle at another location, if an anticipated job number and/or rate would tend to utilize the least utilized vehicle to a greater extent. Such anticipated job number and/or rate estimates may be obtained in view of historical job number and/or rate values for each location, e.g., according to a maximum job length, a greatest number of jobs, or a greater job rate

Vehicle utilization strategies are important to fleet management: balancing utilization balances fleet costs while keeping spare vehicle resources ensures high vehicle availability. The techniques disclosed herein recommend staging and/or locating vehicles to improve and/or optimize for costs and benefits. In the interests of efficiency, it is generally beneficial to maximize utility of each vehicle in a fleet. Utility monitoring may depend upon knowledge of each vehicle's dispatch, a measure of utility, such as a wear and tear on each vehicle, and in at least some embodiments, details of jobs completed and/or jobs to be completed.

By way of example, improving and/or optimizing utilization of a fleet may include a set of decisions on where to store and/or garage vehicles for job assignment. Garages are facilities at fixed locations where technicians begin and end their daily tours—a technician's tour being a route taken between assigned jobs during the technician's work shift time. A decision on where to garage a vehicle is a decision on where to locate it for future job assignments. An infrastructure provider, such as a utility company, may maintain a large fleet that may include different types of moveable equipment, e.g., including vehicles and/or tools, which are provided to complete different jobs (e.g., a bucket truck may be needed to reach an aerial cable termination sixty feet above the ground). In at least some applications, one or more spare vehicles in the fleet may be necessarily maintained at one or more storage locations, e.g., so that vehicle availability is increased and/or maximized. It may be appreciated that any costs of missed jobs and impacted schedules from mechanical failures would justify such a requirement for spare vehicles placed in key locations. In at least some embodiments, spare vehicles may be considered during any evaluations of fleet utilization metrics, e.g., fleet utilization and/or value, and may be utilized with the fleet as well.

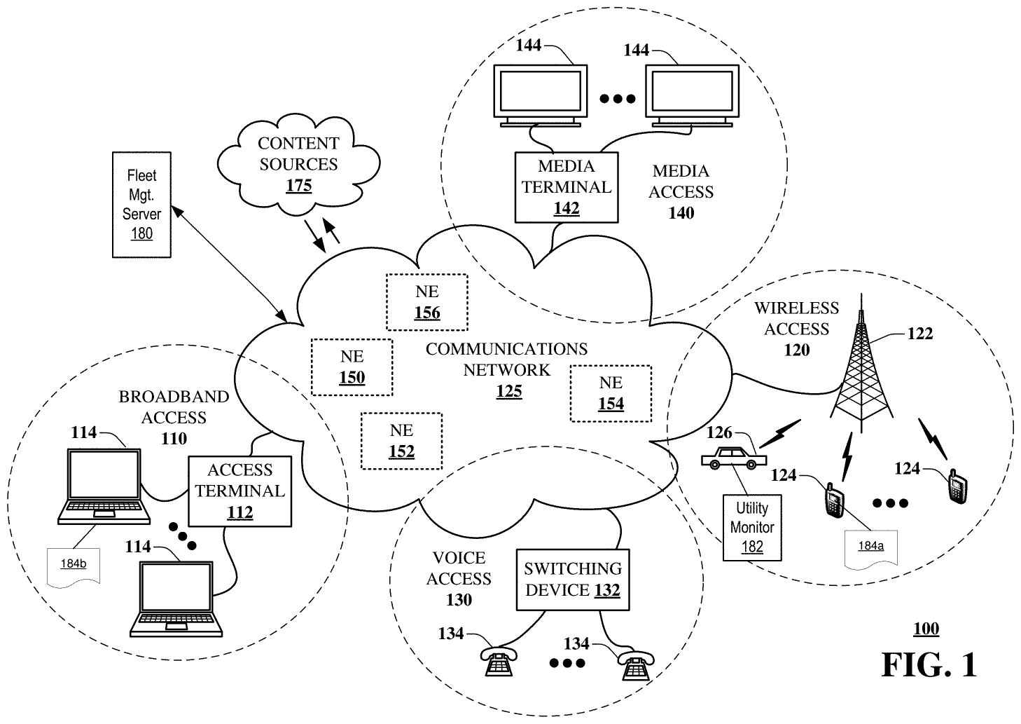

Referring now to FIG. 1, a block diagram is shown illustrating an example, non-limiting embodiment of a system 100 in accordance with various aspects described herein. For example, system 100 can facilitate in whole or in part generating a graph having nodes corresponding to storage facilities, and edges corresponding to distances between pairs of storage facilities. A complexity of the graph in terms of nodes and/or edges may be reduced, e.g., by segmenting the graph into two or more sub-graphs. Utilization values of the moveable assets may be estimated for each node and for each sub-graph, metrics may be calculated as pairwise differences between estimated utilizations less twice the distance between the corresponding storage facilities. Candidate node pairs may be identified as having metric values greater than zero. Node assets are ordered according to utilizations and a transfer recommendation may be identified according to a storage facility pair having a maximum metric and an asset pair utilization having maximum difference. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc., for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc., can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

The system 100 includes at least one capital asset management device or system, referred to herein as a fleet management server 180 facilitating management of a fleet of field equipment, e.g., vehicles, across a dispersed geographic region. According to the illustrative embodiment, a fleet member includes a vehicle 126 that may include a utility monitor 182. The utility monitor 182 may be adapted to monitor one or more measures of usage of the vehicle 126. Usage may include, without limitation, distances traveled, time traveled, operating time, job type and/or job activity, operator, time of day, calendar date, elevation, atmospheric conditions, such as temperature, humidity, salinity, road surface conditions, and so on. In at least some embodiments, the utility monitor 182 is in communication with the communications network 125 via the wireless access network 120.

The example fleet management server 180 is also in communication with the communications network 125 and may receive and/or transmit messages to the vehicle 126. For example, the fleet management server 180 may transmit a query message to the utility monitor 182 requesting an updated utility status of the vehicle 126. The utility monitor 182 may, in turn, transmit a response message to the fleet management server 180 that include one or more of the monitored measures of utility. To the extent a measure of utility includes distance traveled and equipment runtime, the updated distance and runtime information is returned to the fleet management server 180.

In at least some embodiments, one or mobile devices 124 may be configured with instructions, e.g., an app 184a, adapted to interact with one or more of the fleet management server 180 and/or the utility monitor 182. Alternatively or in addition, one or more data terminals 114 may be configured with instructions, e.g., an app 184b, to interact with one or more of the fleet management server 180 and/or the utility monitor 182. Alternatively or in addition, one or more other devices, such as the data terminals 114 may be configured with instructions, such as an app 184b adapted to interact with one or more of the fleet management server 180 and the utility monitor 182. The app 184a, 184b, generally 184, may include a client module adapted to interact with a remote server module, such as the fleet management server 180 according to a client-server relationship. Alternatively or in addition, the app 184 may be adapted to operate in a standalone mode, e.g., performing at least a portion, and up to the entirety, of the processing as it relates to fleet management, e.g., including fleet rebalancing activity.

By way of example, the app 184b supports a fleet management portal that may be accessed by a fleet manager via the data terminal 114. The fleet management portal may present a user interface adapted to identify one or more of fleet members, fleet member types or categories, fleet member utility information, overall fleet information as it may depend upon utility information obtained via the utility monitor 182, and so on. In at least some embodiments, the fleet management portal may provide one or more recommended fleet member swaps adapted to enhance, maximize and/or otherwise optimize a value of the fleet when subjected to future utilization.

For example, a recommended vehicle swap may involve a first vehicle at a first garage facility and a second vehicle at a second, remote garage facility. The first vehicle may be a relatively highly-used vehicle, and the first garage may have a relatively high job tour length. In contrast, the second vehicle may be a relatively low-used vehicle, and the second garage may have a relatively low job tour length. The recommended swap, if implemented, would place the relatively highly used vehicle at the second garage facility, such that future usage would be expected to be lower, based on the second garage's relatively low tour length. The swap would also place the relatively low-used vehicle at the first garage facility, such that future usage would be expected to be higher, based on the first garage's relatively high tour length. Consequently, a difference in utility between the first and second vehicles would be expected to be less when observed at a future time, e.g., after some number of jobs and/or elapsed time period based on the expected tour lengths.

In at least some applications, the fleet management server 180 may operate upon a relatively large number of fleet members, distributed across a number of geographically dispersed garage facilities. The fleet management server 180 may operate so as to optimize a value of an entire fleet. Such an optimization process may be run for all fleet members and all garage facilities, such that recommendations are made in view of the entire fleet. Alternatively, the optimization process may be run in a segmented manner, e.g., considering fleet members among a subset of all garage facilities and making recommended fleet member swaps among the subset of garage facilities without necessarily considering fleet members and/or garage facilities beyond the subset of garage facilities. In some embodiments, a segmented fleet optimization processes may be run independently for different segments according to different schedules. Alternatively or in addition, the segmented fleet optimization process may be run according to a common schedule, such that a rebalancing recommendation is made for the entire fleet, according to the subset of garage facilities. As discussed hereinbelow, an entire set of fleet storage facilities and/or fleet members, may be segmented according to a heuristic process, e.g., based on observable insights as they may relate to fleet management.

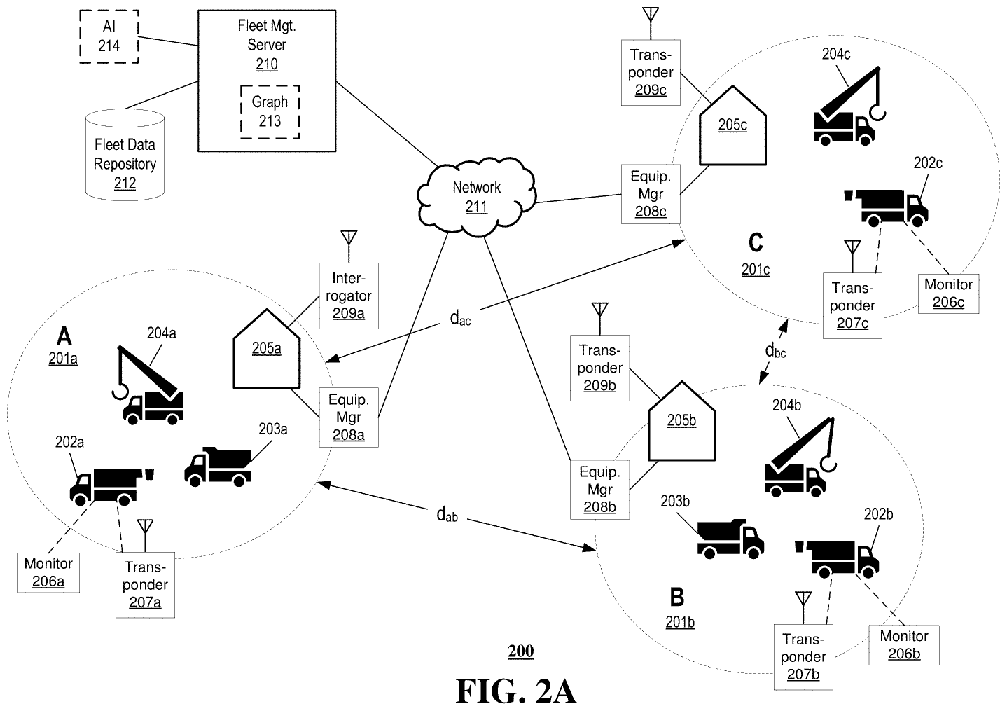

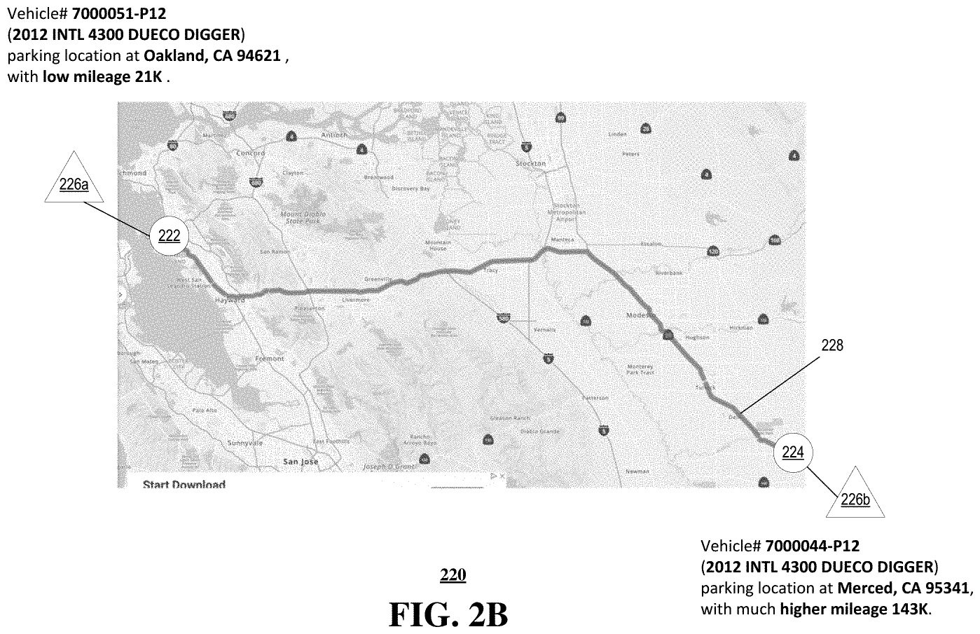

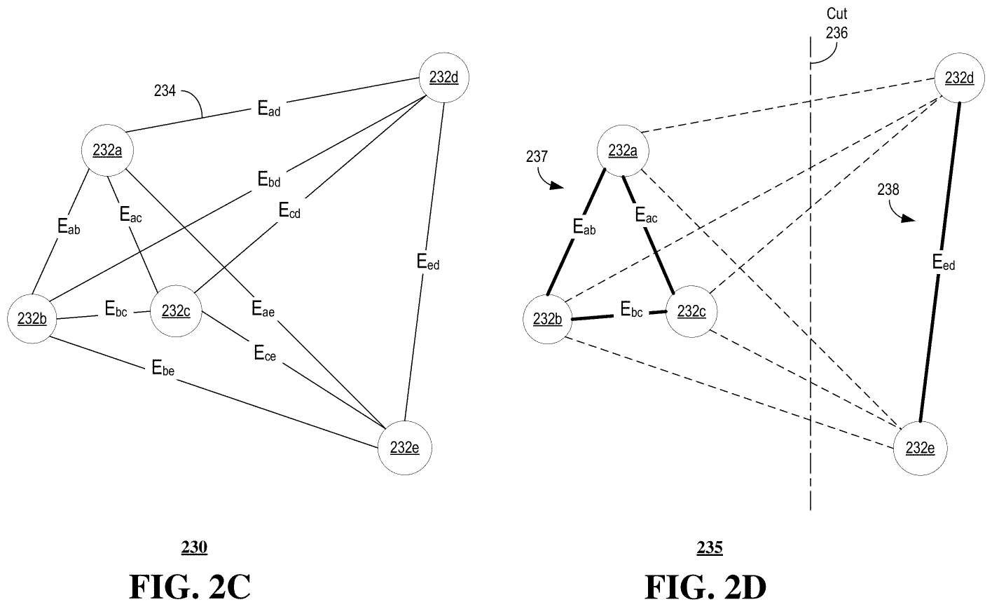

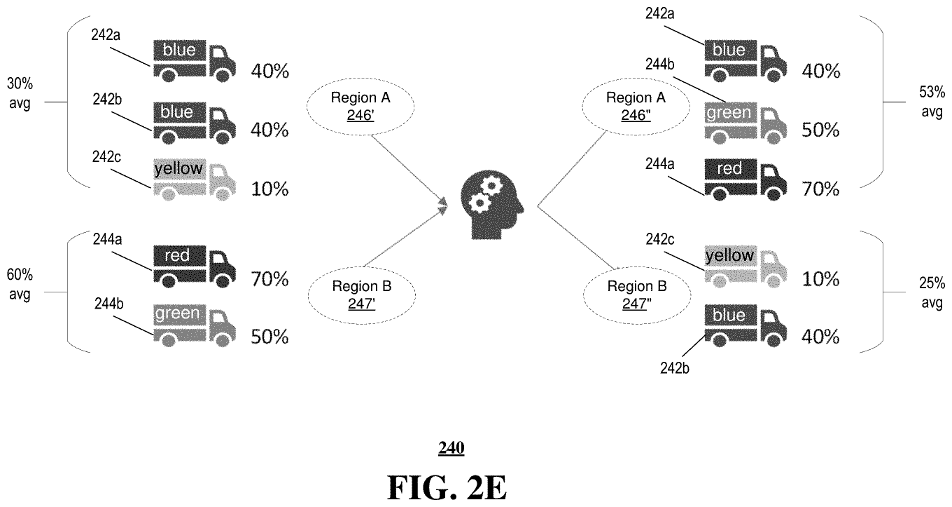

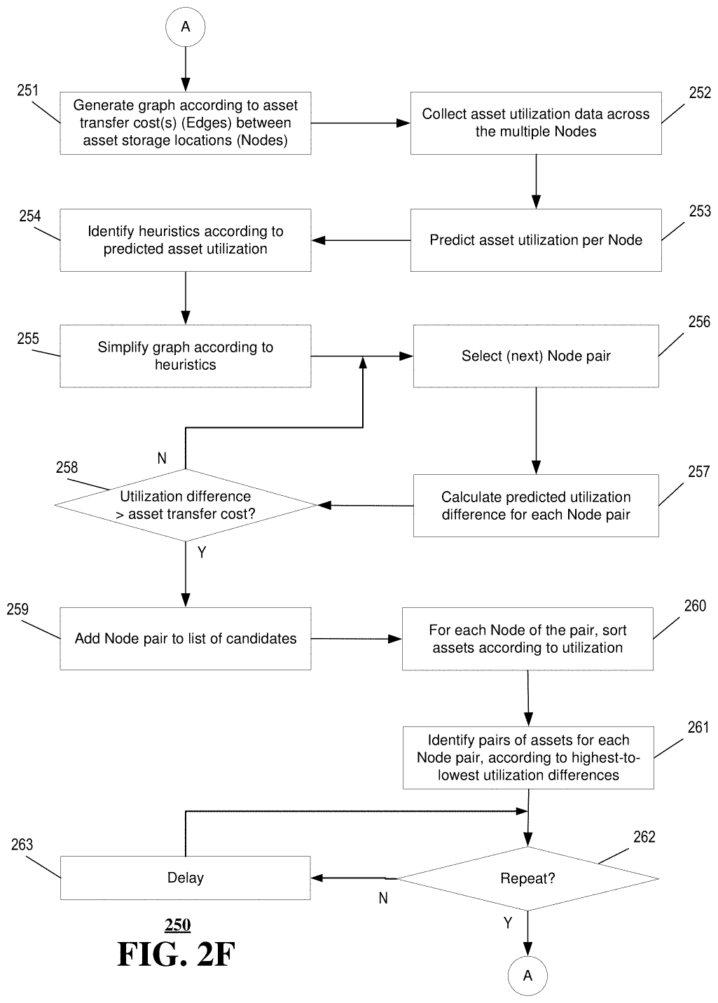

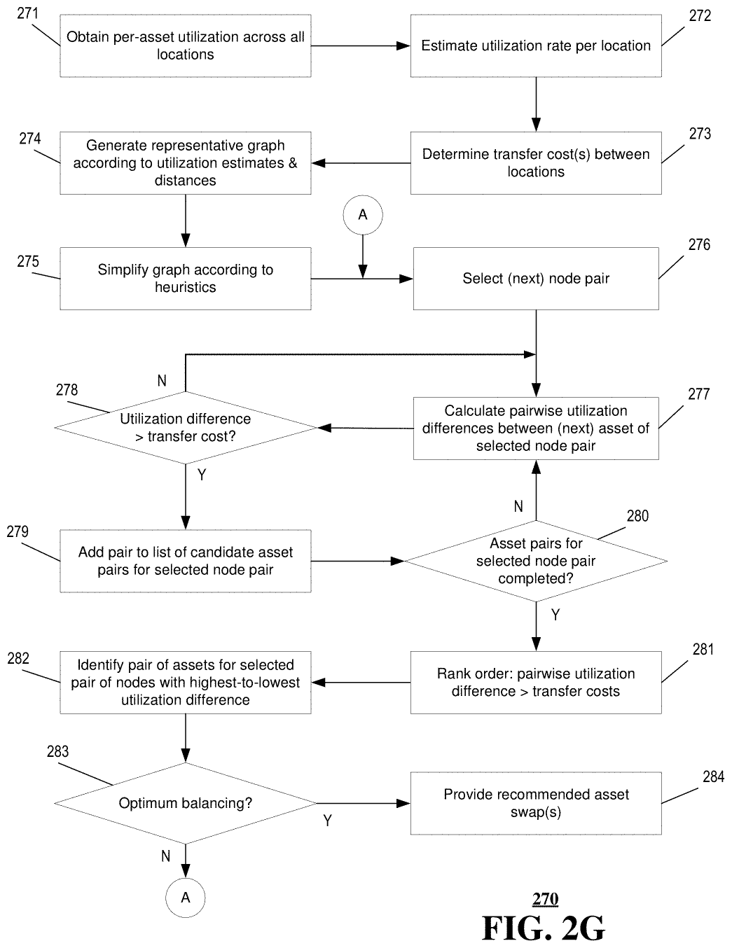

FIG. 2A is a block diagram illustrating an example, non-limiting embodiment of a fleet management system 200 functioning within the communication network 100 of FIG. 1 in accordance with various aspects described herein. The example fleet management system 200 includes a first geographical region A 201a, having a first asset storage facility 205a, a second region B 201b, having a second asset storage facility 205b and a third region C 201c, having a third asset storage facility 205c. The regions 201a, 201b, 201c, generally 201, are illustrated as separate and non-overlapping; however, it is envisioned that in at least some embodiments two or more of the regions 201 may overlap to at least some extent. Generally the regions 201 indicate a geographic range within which the assets operate. For a utility maintenance application, the regions 201 may represent a city, a county, a state, a group of two or more cities, counties and/or states, or more generally any other feasible geographic regions as may be defined according to geographic references, such as GPS coordinates, ranges from a centralized location, and so on. The sizes, e.g., areas and/or shapes of the regions 201 may be approximately the same or different.

According to the example fleet management system 200, distances may be determined between the regions 201. The distances may be relevant to certain calculations, such as cost estimates of transferring assets from one location to another. For example, the value “d_{ab}” represents a distance between the first asset storage facility 205a and the second asset storage facility 205b. Likewise, the value “d_{bc}” represents a distance between the second asset storage facility 205b and the third asset storage facility 205c, and the value “d_{ac}” represents a distance between the first asset storage facility 205a and the third asset storage facility 205c. Distances may be estimated, e.g., according to direct lines between the different storage facilities 205. Alternatively or in addition, the distances may be estimated according to travel routes, e.g., roadways, between the storage facilities 205.

In at least some embodiments, the distance values may be enhanced, e.g., including travel times as may depend upon current traffic and/or weather conditions. Other enhanced considerations may include tolls, elevation differences, road conditions, e.g., paved versus gravel, and so on. It is envisioned that the distances alone or in combination with one or more enhancements may be used to estimate an overall transport cost of a particular asset. It is envisioned that in at least some instances the transport costs may depend upon a characteristic of an asset, such as its size and/or weight restrictions which may limit available travel routes. Other asset characteristics that may contribute to cost may include operator costs, e.g., if special operator licenses are required and/or fuel costs, e.g., vehicle mileage and present fuel costs for the particular region.

The asset storages facilities 205a, 205b, 205c, generally 205, are adapted to store respective groups of fleet members, or assets. Depending upon certain considerations, such as a location of the storage facility 205, a type of asset, and so on, the storage facility may include one or more of a garage, an open lot, fenced in area or pen, a storage locker, and so on. According to the example, the first storage facility 205a stores a first group of assets including a first bucket truck 202a, a first dump truck 203a and a first crane 204a. Likewise, the second storage facility 205b stores a second bucket truck 202b, a second dump truck 203b and a second crane 204b, while the third storage facility 205c stores a third bucket truck 202c and a third crane 204c.

The first bucket truck 202a may include one or more of a utility monitor 206a and a transponder 207a. Likewise, the second bucket truck 202b includes a utility monitor 206b and/or a transponder 207b and the third bucket truck 202c also includes a utility monitor 206c and/or a transponder 207c. One or more of the utility monitors 206a, 206b, 206c, generally 206, may include an onboard monitoring device attached to and/or otherwise integrated into the mobile asset, e.g., an odometer adapted to measure distance traveled and/or a run-time clock adapted to measure equipment and/or engine runtime of the respective bucket truck 202a, 202b, 202c, generally 202.

The storage facility 205a may include one or more of an equipment management system 208a and an interrogator 209a. Likewise, the second storage facility 205b includes an equipment management system 208b and an interrogator 209b and the third storage facility 205c also includes an equipment management system 208c and an interrogator 209c. One or more of the equipment management systems 208a, 208b, 208c, generally 208, may be adapted to receive, track, process and/or report utility information for at least those assets stored at the respective storage facility 205a, 205b, 205c, generally 205.

In at least some embodiments, an interrogator 209a, 209b, 209c, generally 209 may interrogate one or more transponders 207a, 207b, 207c, generally 207, of locally stored assets, such as the example bucket trucks 202. The interrogator 209 may provide interrogation results, e.g., including utility information received from the utility monitors 206 via the transponders 207, include an onboard monitoring device attached to and/or otherwise integrated into the mobile asset, e.g., an odometer adapted to measure distance traveled and/or a run-time clock adapted to measure equipment and/or engine runtime of the respective bucket truck 202a, 202b, 202c, generally 202.

The example fleet management system 200 includes a fleet management server 210 that may be located at one of the storage facilities 205 or at some other remote location. In at least some embodiments, the fleet management server 210 is in communication with one or more of the equipment management systems 208 via a network 211. The fleet management server 210 may receive messages from one or more of the equipment management systems 208 and/or one or more of the assets 202, 203, 204. The fleet management server 210 may execute one or more fleet management processes that operate upon utility information obtained via the utility monitors 206 and/or pre-processed utility information obtained from one or more of the utility monitors 206 and the equipment management systems 208.

Given one or more of vehicle telemetry, maintenance, and repair history data, a vehicle location schedule can be produced that effectively optimizes fleet utilization, e.g., considering operational costs and/or benefits. In at least some embodiments, the fleet management processes are adapted to calculate and/or otherwise estimate a current or present value of a fleet of assets 202, 203, 204. The value may be determined according to a combination, e.g., a sum, of partial fleet values, such as a sum of the values of individual assets 202, 203, 204 and/or a sum of the values of groups of assets, e.g., according to each storage facility 205 and/or the sum of the values of any combination thereof. Evaluations may be based at least in part upon collected utilization data, such as the utilization of a particular asset 202, 203, 204. In some instances, a value may be determined according to a function and/or a tabular reference that equates value with a reference value, e.g., a purchase price of the asset, less some depreciation that may be based upon time, usage, present condition, historical events, such as service repairs, or some combination thereof.

According to the illustrative example, the fleet management server 210 is in communication with a fleet data repository 212. The fleet data repository 212 may store any information that may be useful in implementing the fleet management processes. By way of example, the fleet data repository 212 may store a record of the types of assets that make up the fleet, e.g., bucket trucks 202, dump trucks 203 and cranes 204. Alternatively or in addition, the fleet data repository 212 may store records of individual assets, e.g., property tag numbers, vehicle identification numbers (VIN) and so on. In at least some embodiments, the fleet data repository 212 may store records of purchase prices, purchase dates, maintenance records, locations, owners, asset features, and so on. To the extent that prior utility information has been obtained and/or fleet valuations determined, such historical records may also be retained by the fleet data repository 212. The fleet data repository 212 may be collocated with the fleet management server 210, or remotely located, e.g., accessible via a network, or distributed, e.g., across multiple locations that may include local and/or remote locations. In at least some embodiments, the fleet data repository 212 includes a database management system adapted to facilitate storage and/or retrieval of records as may be useful to fleet managers.

In some embodiments, one or more of the storage facilities 205 may not include an equipment management system 208, or if available, the equipment management systems 208 may be bypassed. In such instances, the fleet management server 210 may obtain information from one or more of the assets 202, 203, 204. In at least some embodiments, the utility information may be obtained with the use of a transponder 207 and interrogator 209. In such instances the interrogator 209 may request utility information according to a schedule and/or at a request received from the fleet management server 210.

FIG. 2B is a graphical representation of an example, non-limiting embodiment of a portion of a system 220 functioning within the communication network 100 of FIG. 1 in accordance with various aspects described herein. According to the illustrative example, a first asset location is a first garage 222 located in Oakland, Calif., postal code 94621, and a second asset location is a second garage 224 located at Merced, Calif., postal code 95341. The first garage 222 stores a first asset 226a, representing a 2012 INTL 4300 DUECO, Inc. digger 226a, having a property reference number 7000051-P12. Similarly, the second garage 224 stores a second asset 226b of a similar kind, also representing a 2012 INTL 4300 DUECO, Inc. digger 226b, having a property reference number 7000044-P12. A possible transfer route 228 suitable for transporting the digger equipment 226a, 226b is identified on a suitable roadway map. Accordingly, if a mutual transfer or swap of the two similar diggers 226a, 226b is considered, the recommended, or possible transfer route 228 may be applied to estimate transfer costs.

In may appreciated that there will be a cost to any transfer event, such as mileage impact on utility, fuel costs, operator costs, time, etc. Thus, any benefit realized by swapping equipment between facilities would at least outweigh the costs of transfer. In view of the transfer costs, it may be beneficial in at least some instances, to select those pairs of equipment having the greatest benefit, e.g., the greatest difference in measures of utility, less any applicable transfer costs. A judicious selection of equipment pairs of all possible pairs may maximize the benefit of any utilization balancing, while achieving this with a minimum number of transfers. For example, the individual benefits of any candidate transfer pairs may be rank ordered, such that transfers may be accomplished in a substantially ordered manner, beginning with those transfers that reap the greatest benefits.

It is also envisioned, that in at least some embodiments, an approximate balancing may be sufficient, e.g., implementing a subset of pairwise transfers in view of all possible candidate pairs. Such approximations may be based on one or more of a number of transfers, e.g., only the top two or three or ten transfers, or the top 10% or 25%, or 50% percent of available candidate pairs. Alternatively or in addition, the valuation of the fleet may be recalculated, e.g., by the fleet management server 210, for different numbers of the possible candidate transfer pairs. Consider calculating the benefit for all possible pairs, then calculating the benefit for each incremental additional pair, beginning with that pair offering the greatest benefit towards balancing utilization and therefore fleet value. Any decision upon which pairs and how many of the possible pairs of assets may be based upon their incremental returns. For example, transferring the first five of twenty possible candidate pairs may achieve 75% of the possible rebalancing improvement. Thus, a decision may be made to only transfer the first five pairs, in the interest of conserving resources. There is also a lost opportunity cost to any vehicles engaging in vehicle transfers as they would not necessarily be available to participate in a job during the transfer period. It is envisioned that om at least some instances, selection of candidate transfer pairs may take into consideration such lost opportunity costs.

FIG. 2C is a block diagram illustrating an example, non-limiting embodiment of a graphical representation, i.e., a graph 230 of the fleet management system 200 of FIG. 2A. The example graph 230 includes five nodes, 232a, 232b, 232c, 232d, 232e, generally 232, corresponding to five different fleet member storage locations. Locations of the nodes 232 roughly correspond to their geographic locations, e.g., as obtained from a map and/or from their respective geocoordinates. Each of the nodes 232 is joined to every other node in the graph 230 by a respective line or edge 234. The edges 234 correspond to transfer costs between the interconnected node pair. For example, a first pair of nodes 232a-232b is joined by a first edge E_{ab}, representing a cost of transferring assts between node 232a and node 232b. By way of at least one simplistic example, the transfer costs may be estimated by a travel distance between the nodes 232a, 232b. Likewise, a second pair of nodes 232b-232c is joined by a second edge E_{bc}, and so on, interconnecting all possible edges. This may be referred to as a complete graph. Additionally, this may be referred to as a non-directed graph, as transfer costs in one direction are equivalent to transfer costs in the other direction. Thus a swap of in kind assets between nodes may be implemented at a cost that may approximate twice the value of the corresponding edge, i.e., twice the distance between the nodes.

It is envisioned, however, that in at least some instances, the transfer costs may not be equivalent in either direction for transfer of an in kind asset between a pair of nodes 232a, 232b. For example, operator costs may differ depending upon which facility the asset is housed. Other contributing factors may include differences in tolls, vehicle mileage, and so on. In such instances, the graph 230 may be modified to include two edges between the same pair of nodes 232, each edge having a corresponding direction with respect to the pair of nodes 232.

A problem of deciding an optimal placement of assets, such as vehicles, can be characterized as a combinatoric optimization problem. As such, it may be associated with a class of problems that is common for optimization questions, but is also not solvable in a general context with a time guarantee that is useful for the asset, e.g., vehicle, and asset storage location, e.g., garage, sizes of a large utility services provider. A deciding job shop scheduling problem is known to be in a complexity class of nondeterministic polynomial time (NP). Accordingly, the problem is solvable using a non-deterministic Turing machine in polynomial time (P). Assuming P≠NP, a polynomial time algorithm does not exist.

It can be shown that generally solving the utilization problem requires a nondeterministic Turing machine in polynomial time. According to a first assumption, the vehicle utilization is solvable in polynomial time using a deterministic Turing machine. It may be recognized that the vehicles in the utilization problem may be analogized to the machines in a job shop scheduling problem (JSP), whereas the jobs in the utilization problem may be analogized to be the jobs in JSP.

According to the JSP, a minimal make-span is sought. In a utilization scenario, a balanced utilization of all vehicles may be sought. Considering utilization in terms of a sum of vehicle values, then under an assumption that a vehicle's value decreases with usage and the function describing value decrease in terms of usage is convex, then the utilization problem generally seeks to maximize vehicle value with each job assignment. Assuming that according to the JSP, the function describing machine utilization is convex and that maximizing utilization will minimize make-span, then the two objective functions may be considered to be substantially equivalent.

Since vehicle utilization can be considered as an equivalent to the JSP, an assumption that there exists a deterministic Turing machine that solves the problem in polynomial time suggests that the method also solves the JSP. Since the JSP has already been shown to be in a complexity class of NP, it may be concluded that the assumption is false.

Thus, given the impossibility of a general solution with concave value functions, the various systems, devices and processes disclosed herein apply a heuristic solver approach. The heuristic solver considers derives insights learned from utilization data in a fleet under evaluation. For example, such insights may indicate that there are garages with higher tour lengths, e.g., in rural areas, proximate to garages with shorter tour lengths, e.g., in urban areas. Alternatively or in addition, fleet management may aim to minimize an overhead in utilization actions. Consider that any utilization actions undertaken in an optimization scenario, should account for costs moving vehicles between garages, or areas.

A first, algorithm 1 describes the combinatoric approach outlined below, sometimes referred to as a brute force approach.

```
Algorithm 1: Combinatoric vehicle pair search:
Data:
Array of vehicles ordered by utilization U;
Triangular matrix of distances between garages G;
Result:
Set of pairs of vehicles to swap garages;
for each vehicle pair (i, j) do:
    e ← g(υᵢ, υⱼ) distance between garages for vehicles (i, j);
    σ ← |Uᵢ − Uⱼ| − 2e;
end;
  Ω ← Ω + v(max(σ))
```

The combinatoric approach considers all vehicle pairs in all garages, under the assumption that distances between garages satisfy the triangular inequality, i.e., the same distance from garage a to garage b as from garage b to garage a. If a utilization difference between two fleet assets, or vehicles, is greater than twice the distance between the two garages then a candidate pair is found. This brute force search is of complexity O(n²), in which n is the number of vehicles in the fleet. This brute force approach for optimizing utilization is not practical for many fleet sizes and garages, such as those as would be applicable for a large utility service provider.

Another solution first reduces a search space size. Such a reduction may include application of a heuristic process. For example, a search space of a complete graph of garages may be reduced by segmenting the graph of garages that base the fleet into two or more sub-graphs. FIG. 2D is a block diagram illustrating an example, non-limiting embodiment of a heuristic-modified graphical representation 235 of the graph 230 of FIG. 2B and the fleet management system 200 of FIG. 2A in accordance with various aspects described herein. According to the illustrative example, the original graph of five nodes 232, has been simplified by removal of a group of edges 234. Consequently, edge removal has resulted in multiple sub graphs. In the particular example, six edges have been removed, resulting in two distinct sub-graphs. Namely, a first sub-graph 237 includes three nodes 232a, 232b, 232c and a second sub-graph 238 includes two nodes 232d, 232e. Remaining edges between the nodes of each subgraph are representative of transfer costs of assets between the nodes 232. The illustrative example includes cut 236, drawn as a line from top to bottom that interests each of the removed edges, without intersecting any of the preserved edges 234.

By way of example, at least one heuristic process for segmenting a graph is based upon observed vehicle tour lengths of the different garages. Vehicle tour lengths may include engine hours, mileage driven, or a combination thereof, while a technician is completing field jobs from a respective garage. The expected tour lengths can be collected from tours observed from each vehicle in a garage and considered as an estimate of the tour lengths that a vehicle will experience on future jobs. In at least some embodiments, the tour lengths of vehicles of a garage may be combined, e.g., according to statistics. Such statistical values may include, without limitation, a mean tour length, a modal tour length, a maximum tour length and/or a minimum tour length. Other considerations may include a total number of tours within a given observation period, a touring rate, a job type, e.g., that may be used to distinguish tours, a vehicle type, to name a few.

A garage distance matrix is a matrix of nonnegative floating point values where values are the driving distances between two garages. For all garage pairs, the method estimates the utility of swapping vehicles using |tᵢ−tⱼ|−2×d(i, j) (the difference between the difference of expected tour lengths and the twice the distance between garages see 2).

```
Algorithm 2: Heuristic garage candidate pairs:
Data:
λ: expected tour lengths for garages;
γ: garage graph where edge weights are distances;
k: number of garage clusters to evaluate;
Result:
w: ordered list of candidate vehicle pairs;
divide graph into k clusters, and for each graph cluster do:
  for each garage pair (i, j) do:
    w ← w + |tᵢ − tⱼ| − 2 × d(i, j)
  end;
  sort w filter w for values greater than zero;
end;
foreach garage pair in w do:
  sort vehicles by utilization in each garage recommend vehicle pairs
  (highest in a, lowest in b);
end.
```

The method recovers pairs of garages where the difference in the expected tour lengths is more than twice the distance between garages. This heuristic measure estimates pairs of garages where vehicle swaps will likely improve fleet utilization. Given a target utilization value, the method then recommends swaps by enumerating the ordered garage pair list and identifying specific vehicle pairs. The computational complexity of identifying garage pairs is O(G²+GV) where G is the number of garages housing the fleet and V is the number of vehicles within each garage. Where the number of vehicles is much greater than the number of garages, the proposed method is more efficient than the naive brute force method (see slides for a practical example).

The method can generate swap recommendations at a vehicle tour level (i.e., run as each vehicle tour completes). In practice, a sufficient number of vehicle tours needs to complete so that a significant vehicle utilization difference exists for swaps to be effective. This represents another optimization decision, but in practice the method should be applied at a frequency that allows for sufficient utilization imbalances to emerge (e.g. every three months).

FIG. 2E is a graphical representation of an example application of a non-limiting embodiment of a system 240 functioning within the communication network of FIG. 1 and according to the graphical representation of the asset management system of FIG. 2A, in accordance with various aspects described herein. The illustration includes a first region A 246′, serviced by three vehicles 242a, 242b, 242c, generally 242, and a second region B 247′, serviced by two vehicles 244a, 244b, generally 244. For illustrative purposes, all of the vehicles 242, 244 are of a similar kind, e.g., a bucket truck. Illustrated next to each of the vehicles is an example utilization value, e.g., a percentage utilization as in a percentage of a vehicle lifetime. The vehicles 242, 244 may be housed at respective garage facilities of region A 246′ and region B 247′.

With respect to an initial condition at region A 246a′, the first vehicle 242a has a utilization value of about 40%. Considering a 100,000 miles as 100% utilization for a vehicle, this corresponds to a 40,000 miles odometer reading. Likewise, the second vehicle 242b has a utilization value of about 40%, i.e., 40,000 miles, and the third vehicle 242c has a utilization value of about 10%, i.e., 10,000. With respect to an initial condition at region B 247a′, the first vehicle 244a has a utilization value of about 70%, i.e., 70,000 miles, and the second vehicle 244b has a utilization value of about 50%, i.e., 50,000 miles. An average utilization may be obtained for each region, e.g., by taking an average of the corresponding utilization values. Thus, an initial utilization value for the vehicles 242 at region A 246′, would be about 30% utilization. Likewise, an initial utilization value for the vehicles 244 at region B 247′, would be about 60% utilization.

An average tour length for a job may also be calculated for each of the regions 246′, 246″. For illustrative purposes, assume that region A 246′ has an average tour length of about 100 miles, e.g., a rural area, while region B 247′ has an average tour length of about 10 miles, e.g., an urban area. The average tour lengths may be considered as expected tour lengths for future jobs handled by vehicles at each respective garage. Insight into the substantial difference in expected tour lengths may be used to identify the regions 246′, 247′ as a candidate garage pair to consider swapping of vehicles. According to the example scenario, all pairs represent candidate pairs.

To the extent a distance between the garages is 40 miles, the difference in expected tour lengths would be 90 miles, while twice the distance between the garages would be 80 miles. As it turns out, the garage pair of region A 246′ and region B 247′ would represent a candidate pair for swapping vehicles. A next step would be to identify candidate vehicles to be swapped. In order to obtain the greatest impact, a vehicle with the greatest utilization could be swapped with a vehicle with the least utilization. Accordingly a first vehicle 244a of region B 247, having a utilization of 79% is swapped with a third vehicle 242c of region A 246′. A second swap may be implemented, e.g., by swapping the next highest utilized vehicle with the next least utilized vehicle. In this instance, the second vehicle 244b of region B 247′ would be swapped with a second vehicle 242b of region A 246′.

A resulting vehicle locations are shown in a post-swap region A 246″, having the original first vehicle 242a, and the first and second vehicles 244a, 244b, received from region B 247′. Likewise, a post-swap region B 247″ has the second and third vehicles 242b, 242c, received from region A 246′. average values of the utilizations are illustrated, reflecting a shift, from region B 247′ initially having a greatest average utilization, to region A 246″ having the greatest average utilization. To the extent past trends in utilization continue, future utilizations encountered by the vehicles in region B 247″ would tend to outpace those encountered by the vehicles in region A 246″, thereby tending to increase the average utilization in region B 247″ at a greater pace than in region A 246″, such that the utilizations would trend towards balancing. Balancing utilization may ensure vehicle resource consumption and gives visibility into spare resources.

FIG. 2F depicts an illustrative embodiment of a mobile asset management process 250 in accordance with various aspects described herein. The process 250 includes generating, at 251, a graph having a group of nodes corresponding to asset storage locations and interconnecting lines or edges extending between the nodes. The edges correspond to costs to transfer assets between the interconnected nodes. According to at least one measure, the cost may correspond to distances between locations corresponding to the interconnected nodes. It is understood that a complexity of the graph may depend on many factors, such as a number of the nodes, a number of the edges, a number of different types of fleet members that may be stored at different storage locations represented by the nodes of the graph, and so on.

Asset utilization data is collected, at 252, across the fleet of moveable assets stored according to respective groups, at the different storage locations represented by the nodes of the graph. A group may correspond to those fleet members that may be present at a particular storage location and/or assigned for storage at that location. Thus, some storage locations may have one fleet member, others may have several and still others may have none. Utilization data may be collected directly from the fleet members, e.g., from the vehicles themselves, and/or from equipment management systems that may be provided at one or more of the storage locations. The equipment management systems may obtain utilization data form any collocated vehicles and provide it to a centralized fleet management server adapted to implement one or more portions of the example process 250. In at least some instances, utilization data may be entered manually, e.g., by recording equipment logbook entries at the equipment management systems and/or using the centralized fleet management system. Utilization data may include vehicle telemetry information, operator logs, input from external systems, such as gate or facility monitoring systems adapted to detect and track departures and/or returns of vehicles to the storage facility, and so on.

Predictions of utilization are formed, at 253, for each of the different locations represented by the nodes of the graph. In at least some embodiments, predicted utilizations for a storage location associated with one of the graph nodes are based on observed utilizations of equipment stored at and/or otherwise operating from that storage location. Utilizations data may be obtained according to a schedule and/or an event. For example, utilization data may be tracked on a per job basis, on a per shift bases, according to a daily, weekly, or some other predetermined time period. The observed utilization data may be considered as a prediction for future utilizations of similar fleet members operating from the same storage location. In at least some embodiments, predicted utilization may be determined according to an offset and/or adjustment of the observed utilization data. For example, utilization of certain equipment, such as vehicles serving as snowplows may vary according to a seasonal basis. Thus, observations made during a summer or fall period may not provide the best indications as predicted utilization values. However, having insight into seasonal variations, certain adjustments may be made. For example, a ratio may be observed that a dump truck may be used twice as much during winter months as non-winter months for the same location. Thus, observed utilization during the fall may be doubled as a predictor of usage during an upcoming winter period.

A heuristic process is applied, at 254, to gain insight into utilization of fleet members across the different locations. Heuristic processes may include any process that offers insight into one or more aspects of the problem, such as distances, utility variations, seasonal variations, operator idiosyncrasies that may affect utilization, a presence or absence of a particular type of fleet member at a particular location, and so on.

The original graph is simplified, at 255, according to the heuristic process to obtain a simplified graph. For example, a node and/or any interconnecting edges may be removed from the graph in response to a determination that the node does not include an asset being evaluated. Alternatively or in addition, other proximate nodes may be characterized according to features that can be valuable indicators of relative utilization trends. For example, one node may be known to represent an urban location, for which it may be presumed that an average tour length is relatively low. Likewise, another node may be known to represent a rural location, for which it may be presumed that an average tour length is relatively high. Such insights may be used to identify likely node pairs and to exclude other unlikely node pairs. Consequently, a graph may be partitioned into two or more subgraphs based on such heuristic processes. In at least some embodiments, the partitioned graphs may be evaluated independently, e.g., having all swaps recommended from within the respective sub graphs. In such instances, a total fleet metric, e.g., utilization and/or valuation may be obtained by first obtaining partial results for each sub-graph and then combining the partial results for a fleetwide result.

A node pair of the simplified graph is selected at 256. In at least some embodiments, all node pairs of each subgraph are considered. Node pairs may be selected at random, or sequentially according to a system, such as a geographic location, e.g., left to right and top to bottom, a reference identification number, e.g., sequentially, an alphanumeric name, e.g., alphabetic order, and so on. In some embodiment, each of the sub graph nodes are provided with an index reference number, e.g., running from an initial value, such as 1 up to a maximum number, n, nodes of the respective sub-graph. In such instances, a sequential selection of node pairs may be identified according to the corresponding index reference numbers.

A predicted utilization difference is calculated, at 257, between the nodes of the selected node pair. The utilization difference may be determined according to the predicted utilization values for that particular node and for that particular type of fleet asset. The utilization difference may be obtained by simply taking an absolute value of a difference of the two utilization values for the corresponding pair of nodes.

A determination is made, at 258, as to whether the utilization difference is greater than a corresponding asset transfer cost. The transfer costs may be identified according to the graph edge values, e.g., reflecting a travel distance between nodes. As a swap of fleet members would require two trips along the same path represented by the graph edge, the transfer cost can be estimated as twice the edge value, e.g., twice the travel distance between the nodes. Candidate nodes pairs may be identified as those node pairs having utilization difference greater than twice the travel distance between nodes. Thus, to the extent it is determined at 258 that the utilization difference is not greater than the corresponding asset transfer cost, the process 250 proceeds from 256 by select a next node pair. To the extent it is determined at 258 that the utilization difference is greater than the corresponding asset transfer cost, the selected node pair is added to a list of candidate node pairs.

For each node of the selected node pairs of the simplified graph, the corresponding fleet members at each respective node are sorted at 260, according to utilization and/or value. For example, a list of assets at each location are sorted from a lowest utility value to a highest utility value for each respective asset. One or more pairs of assets, including a respective asset from each node of the pair, are identified at 261 as a recommended swap pair. For example, a recommended pair may include a highest value from one node of the node pair and a lowest value from another node of the node pair. Identifying assets with the greatest spread in utilization values can indicate a maximum opportunity. Namely, a swap involving equipment with the greatest spread in utilization will have the greatest overall effect in balancing utilization.

In at least some embodiments, the process 250 may continue in a similar manner for more than one node pairs of each sub-graph, selecting a next optimal pair as a recommended swap according to an opportunity cost comparison. A next recommended pair may come from the next widest utilization difference for the first node pair. Alternatively, the next recommended pair may come from assets of another candidate node pair. Any determination as to which selection provides the greatest impact towards utility equalization and/or value maximization, may include comparisons of the utility differences less transfer costs, for the various possible asset pairs.

In at least some embodiments, the process 250 may repeat. To this end, a decision is made, at 262, as to whether the process 250 should be repeated. To the extent it is determined at 262 that the process should not repeat yet, the process may delay, at 263, before returning to the repeat step at 262. However, to the extent it is determined at 262 that the process should be repeated, the process 250 returns to step 251, proceeding therefrom in a like manner as described hereinabove. The repeat schedule may be accomplished on a job bases, e.g., after completion of some number of jobs, such as each job. Alternatively or in addition, the repeat schedule may be accomplished according to a time schedule, such as expiration of a predetermined time period. Alternatively or in addition, the repeat schedule may be accomplished according to a fleet calculation, such as a fleet utilization balance, imbalance and or value.

FIG. 2G depicts an illustrative embodiment of another mobile asset management process 270 in accordance with various aspects described herein. According to the process 270, a per-asset utilization is obtained, at 271, across all members of a fleet of moveable assets as may be provided at a number of geographically diverse available and/or participating asset storage locations. The fleet members may be stored at one or more of the storage locations in groups of one or more.

Estimates of expected utilization, e.g., utilization rates, and/or tour lengths, are obtained, at 272, according to a per location basis. In at least some embodiments, the expected utilizations are based upon prior observations, such as actual utilizations of one or more of the same and/or similar fleet assets at each of the locations. Actual utilization values for a group of assets at each location may be combined into a single expected utilization value, by any suitable process, such as averaging.

Transfer cost(s) between locations are determined at 273, according to any of the example techniques disclosed herein or otherwise known to obtain transfer costs. In at least one simplistic version, the transfer costs may be represented by a travel distance between nodes.

A representative graph is generated, at 274, according to utilization estimates & distances. The graph includes a number of nodes representing the different asset storage locations for which expected utilization values have been obtained. The nodes are interconnected in a pairwise sense by edges. The edges may represent transfer costs, e.g., the travel distance between interconnected nodes. Beneficially, the resulting graph may be simplified, at 275, according to heuristics. Simplification may include removal of one or more nodes, one or more edges and/or separation of the graph into two or more subgraphs. In at least some instances, the subgraphs may be isolated. In some embodiments, the graph may be simplified according to a minimum k-cut.

A node pair is selected, at 276, representing a pair of interconnected nodes of a subgraph. Pairwise utilization differences between a first pair of asset of selected node pair is calculated at 277. The utilization differences may be calculated according to the single expected utilization values associated with node values of the sub-graph.

A value is obtained via calculation of a utilization difference between the selected node pair and a determination made, at 278, as to whether the calculated value is greater than a transfer cost between the selected node pair. To the extent it is determined at 278 that the utilization difference is not greater than the transfer cost, a calculation of a pairwise utilization between a next asset of the selected node pair is repeated at 277.

However, to the extent it is determined at 278 that the utilization difference is greater than the transfer cost, the corresponding node pair is added, at 279, to list of candidate asset pairs for selected node pairs.

A determination is made, at 280, as to whether evaluation of the different possible asset pairs for selected node pair has completed. To the extent it is determined at 280 that additional asset pairs remain to be evaluated, the process 270 returns to calculation pairwise utilization differences, at 277, between a next asset of the selected node pair.

However, to the extent it is determined at 280 that all possible asset pairs have been evaluated, those pairs of assets having pairwise utilization differences greater than transfer costs are rank ordered, e.g., from lowest to highest, or vise versa. Pairs of assets are identified, at 282, for the selected pair of nodes having the highest to lowest expected utilization differences. Such expected utilization differences provide an indication of how future usage will affect a balancing of asset utilization across a sub graph of a fleet.

A determination is made, at 283, as to whether the identified pair of assets for a selected pair of nodes represents an optimum balancing choice. To the extent it is determined at 283 that the identified pair of assets does represent an optimum balancing choice, a recommendation is made, at 284, to swap the identified pair of assets. The recommendation may be provided as a maintenance order using an existing maintenance ordering system. Alternatively or in addition, the recommendation may be added to a list of recommendations for further evaluation at a fleet level, which may opt to prune and/or otherwise modify a recommended list. To the extent it is determined at 283 that the identified pair of assets does not represent an optimum balancing choice, the process 270 may return to select a next node pair at 276, proceeding therefrom as described hereinabove.

While for purposes of simplicity of explanation, the respective processes 250, 270 are shown and described as a series of blocks in FIGS. 2F and 2G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

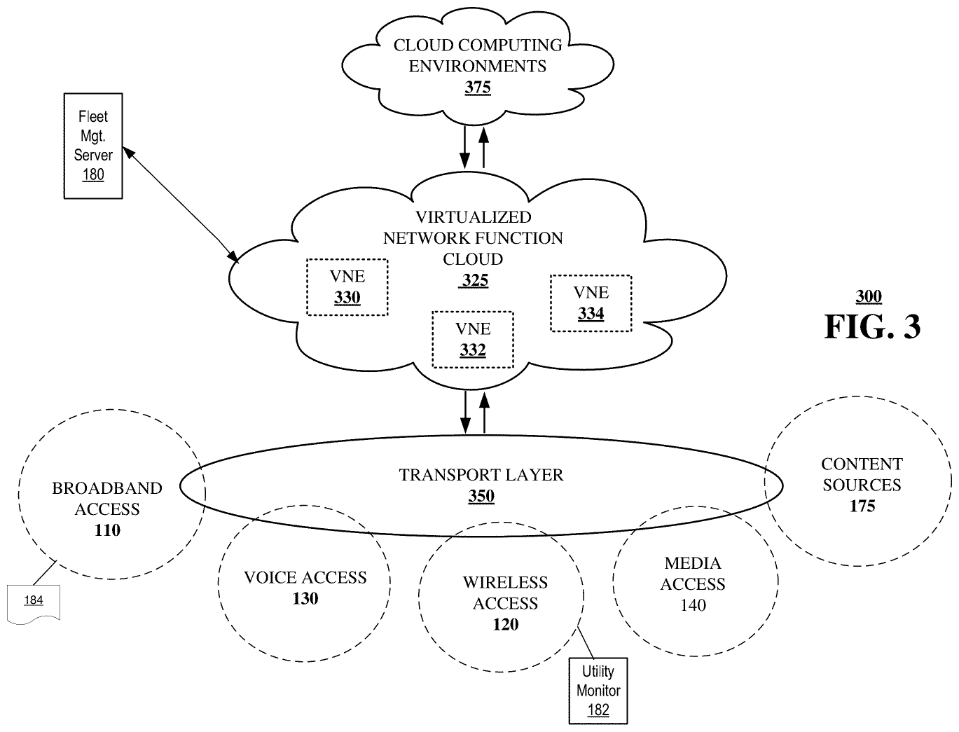

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of the fleet management system 200, and processes 250, 270 presented in FIGS. 1, 2A, 2C, 2D, 2F, 2G and 3. For example, virtualized communication network 300 can facilitate in whole or in part generating a graph having nodes corresponding to storage facilities, and edges corresponding to distances between pairs of storage facilities. A complexity of the graph in terms of nodes and/or edges may be reduced, e.g., by segmenting the graph into two or more sub-graphs. Utilization values of the moveable assets may be estimated for each node and for each sub-graph, metrics may be calculated as pairwise differences between estimated utilizations less twice the distance between the corresponding storage facilities. Candidate node pairs may be identified as having metric values greater than zero. Node assets are ordered according to utilizations and a transfer recommendation may be identified according to a storage facility pair having a maximum metric and an asset pair utilization having maximum difference.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements — which are typically integrated to perform a single function, the virtualized communication network employs virtual network elements (VNEs) 330, 332, 334, etc., that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc., to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers — each of which adds a portion of the capability, and overall which creates an elastic function with higher availability than its former monolithic version. These virtual network elements 330, 332, 334, etc., can be instantiated and managed using an orchestration approach similar to those used in cloud compute services.

The cloud computing environments 375 can interface with the virtualized network function cloud 325 via APIs that expose functional capabilities of the VNEs 330, 332, 334, etc., to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

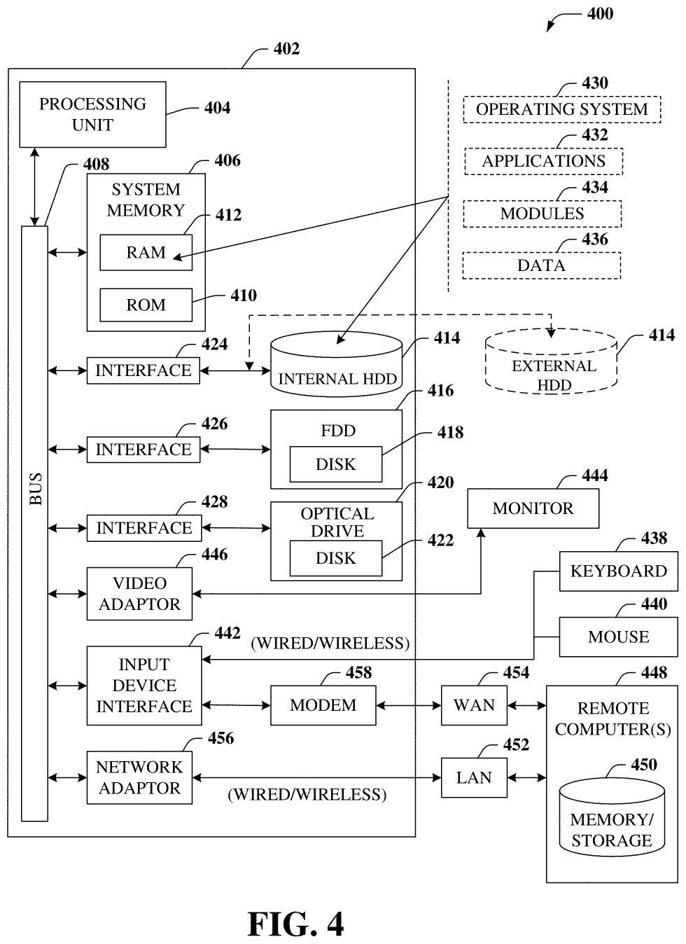

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part generating a graph having nodes corresponding to storage facilities, and edges corresponding to distances between pairs of storage facilities. A complexity of the graph in terms of nodes and/or edges may be reduced, e.g., by segmenting the graph into two or more sub-graphs. Utilization values of the moveable assets may be estimated for each node and for each sub-graph, metrics may be calculated as pairwise differences between estimated utilizations less twice the distance between the corresponding storage facilities. Candidate node pairs may be identified as having metric values greater than zero. Node assets are ordered according to utilizations and a transfer recommendation may be identified according to a storage facility pair having a maximum metric and an asset pair utilization having maximum difference.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM),flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

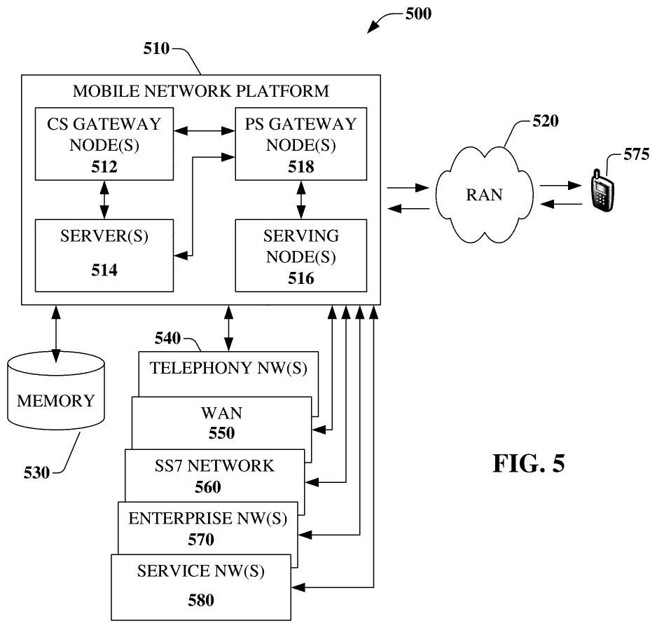

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part generating a graph having nodes corresponding to storage facilities, and edges corresponding to distances between pairs of storage facilities. A complexity of the graph in terms of nodes and/or edges may be reduced, e.g., by segmenting the graph into two or more sub-graphs. Utilization values of the moveable assets may be estimated for each node and for each sub-graph, metrics may be calculated as pairwise differences between estimated utilizations less twice the distance between the corresponding storage facilities. Candidate node pairs may be identified as having metric values greater than zero. Node assets are ordered according to utilizations and a transfer recommendation may be identified according to a storage facility pair having a maximum metric and an asset pair utilization having maximum difference. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, which facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc., that perform particular tasks and/or implement particular abstract data types.

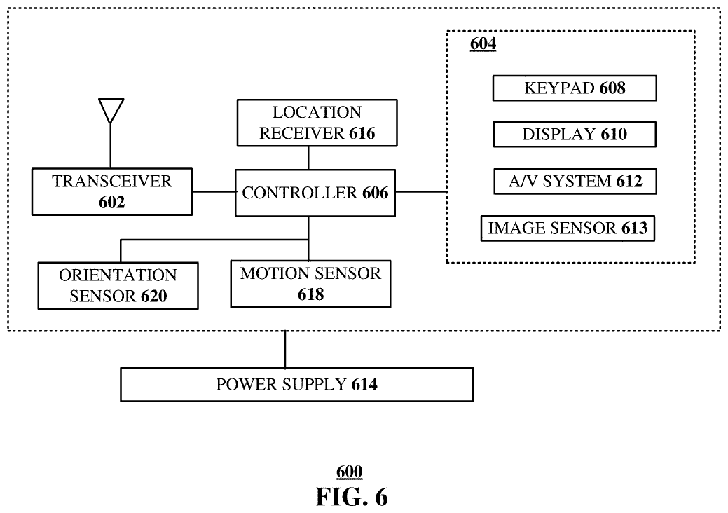

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part generating a graph having nodes corresponding to storage facilities, and edges corresponding to distances between pairs of storage facilities. A complexity of the graph in terms of nodes and/or edges may be reduced, e.g., by segmenting the graph into two or more sub-graphs. Utilization values of the moveable assets may be estimated for each node and for each sub-graph, metrics may be calculated as pairwise differences between estimated utilizations less twice the distance between the corresponding storage facilities. Candidate node pairs may be identified as having metric values greater than zero. Node assets are ordered according to utilizations and a transfer recommendation may be identified according to a storage facility pair having a maximum metric and an asset pair utilization having maximum difference.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1×, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as

PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The

UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

It is understood that one or more of the foregoing disclosed embodiments may provide an optimal solution, or at least approximate an optimal solution. Optimal may refer to one or more criteria, such as maximizing, or achieving a relativley high valuation for a fleet, balancing utilization across fleet members, e.g., reducing and/or minimizing difference in fleet member utilziation. More generally, it is understood that one or more of the techniques disclosed herein may improve and/or increase valuation and/or utilization in a manner that may or may represent an optimum solution, but providing at least an improved solution, such as improving utilization while also satisfying one or more other criteria.

This illustrative examples disclosed herein refer to fleets and fleet members, e.g., in terms of vehicles. It is understood that the techniques disclosed herein may apply more generally to other equipment of a collection, such as generators, tools, and the like, in which choices are available as to which item performs a job. More generally, the techniques may be applied to any moveable asset, and particularly capital assets for which costs and/or value and/or depreciations are being tracked, provided that the asset may be moved and/or otherwise relocated to optimize an overall value, cost and/or benefit of a collection of like assets.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
generating, by a processing system including a processor, a graph comprising a plurality of nodes corresponding to a plurality of garage facilities and a plurality of edges joining a plurality of interconnected node pairs of the plurality of nodes, the plurality of edges corresponding to a plurality of inter-garage distances between the interconnected node pairs;
reducing, by the processing system, a number of the plurality of interconnected node pairs of the graph to obtain a simplified graph;
predicting, by the processing system, a plurality of vehicle tour lengths to obtain a plurality of predicted vehicle tour lengths corresponding to the plurality of nodes, a tour length of the plurality of vehicle tour lengths obtained during an event in which a vehicle of a fleet of vehicles travels from and returns to a garage facility of the plurality of garage facilities;
calculating, by the processing system and for each of the plurality of interconnected node pairs of the simplified graph, a difference in respective predicted vehicle tour lengths of the plurality of predicted vehicle tour lengths less a respective round-trip distance of the plurality of inter-garage distances to obtain a plurality of interconnected node comparison values;
selecting, by the processing system, a candidate interconnected node pair of the plurality of interconnected node pairs according to the plurality of interconnected node comparison values; and
recommending, by the processing system, transfer of a recommended pair of vehicles of the fleet of vehicles between the garage facilities corresponding to the candidate interconnected node pair, wherein a transfer of the recommended pair of vehicles facilitates lifecycle management of the fleet of vehicles.

2. The method of claim 1, wherein the simplifying of the graph further comprises identifying a heuristic, the simplifying of the graph based on the heuristic.

3. The method of claim 2, wherein the identifying the heuristic further comprises recognizing candidate node pairs of the simplified graph without the calculating of the difference in respective predicted asset utilization values.

4. The method of claim 3, wherein the simplifying of the graph further comprises removing at least one edge according to the identifying of the heuristic.

5. The method of claim 3, wherein the simplifying of the graph further comprises separating the graph into a first sub-graph and a second sub-graph, wherein the calculating, the identifying and the recommending are repeated independently for each of the first and second sub-graphs to obtain different recommended pairs of mobile assets according to each of the first and second sub-graphs.

6. The method of claim 5, wherein the first and second sub-graphs do not share any nodes of the plurality of nodes.

7. The method of claim 1, wherein a first node of the candidate interconnected node pair comprises a first group of vehicles of the fleet of vehicles and a second node of the candidate interconnected node pair comprises a second group of vehicles of the fleet of vehicles, the method further comprising:
identifying a first vehicle of the first group of vehicles having a highest utilization value among the first group of vehicles; and
identifying a second vehicle of the second group of vehicles having a lowest utilization value among the second group of vehicles, wherein the recommended pair of vehicles comprises the first vehicle and the second vehicle.

8. The method of claim 1, wherein the fleet of vehicles comprises a spare vehicle retained in a reserve capacity.

9. The method of claim 1, wherein the fleet of vehicles comprises construction equipment.

10. The method of claim 9, wherein the construction equipment comprises equipment adapted for different job types.

11. A system, comprising:
a processing system including a processor; and
a memory that stores executable instructions that, when executed by the processing system, facilitate performance of operations, the operations comprising:
generating a graph comprising a plurality of nodes corresponding to a plurality of mobile asset storage locations and a plurality of edges joining a plurality of interconnected node pairs of the plurality of nodes, the plurality of edges corresponding to a plurality of transfer costs of a mobile asset of a plurality of mobile assets between the interconnected node pairs;
simplifying the graph to obtain a simplified graph having a reduced number of interconnected pairs of the plurality of nodes;
predicting a plurality of asset utilization values to obtain a plurality of predicted asset utilization values corresponding to the plurality of nodes;
calculating, for each of the plurality of interconnected node pairs of the simplified graph, a difference in respective predicted asset utilization values of the plurality of predicted asset utilization values less a respective mobile asset transfer cost of the plurality of transfer costs of the mobile asset to obtain a plurality of interconnected node comparison values;
identifying a candidate interconnected node pair of the plurality of interconnected node pairs according to the plurality of interconnected node comparison values; and
recommending transfer of a pair of mobile assets of the plurality of mobile assets between the candidate interconnected node pair to obtain a recommended pair of mobile assets, wherein a transfer of the recommended pair of mobile assets facilitates lifecycle management of the plurality of mobile assets.

12. The system of claim 11, wherein a first node of the candidate interconnected node pair comprises a first group of mobile assets of the plurality of mobile assets and a second node of the candidate interconnected node pair comprises a second group of mobile assets of the plurality of mobile assets, the operations further comprising:
identifying a first mobile asset of the first group of mobile assets having a highest actual utilization value among the first group of mobile assets; and
identifying a second mobile asset of the second group of mobile assets having a lowest actual utilization value among the second group of mobile assets, wherein the recommended pair of mobile assets comprises the first mobile asset and the second mobile asset.

13. The system of claim 11, wherein the simplifying of the graph further comprises identifying a heuristic, the simplifying of the graph based on the heuristic.

14. The system of claim 13, wherein, wherein the identifying the heuristic further comprises recognizing candidate node pairs of the simplified graph without the calculating of the difference in respective predicted asset utilization values.

15. The system of claim 14, wherein, wherein the simplifying of the graph further comprises removing at least one edge according to the identifying of the heuristic.

16. The system of claim 11, wherein the plurality of predicted asset utilization values are determined according to per event bases, the plurality of predicted asset utilization values comprising one of miles traveled per event, or engine run-time per event, or a combination thereof.

17. A non-transitory, machine-readable medium, comprising executable instructions that, when executed by a processing system including a processor, facilitate performance of operations, the operations comprising:
generating a graph comprising a plurality of nodes corresponding to a plurality of asset storage locations and a plurality of edges joining a plurality of interconnected node pairs of the plurality of nodes, the plurality of edges corresponding to a plurality of transfer costs of an asset of a plurality of assets between the interconnected node pairs, wherein the graph comprises a complexity according to one of a number of nodes of the plurality of nodes, a number of edges of the plurality of edges, or both;
reducing the complexity of the graph to obtain a modified graph;
estimating a plurality of asset utilization values corresponding to the plurality of nodes;
calculating, for each of the plurality of interconnected node pairs of the modified graph, a difference in respective asset utilization values of the plurality of asset utilization values less a respective asset transfer cost of the plurality of transfer costs of the asset to obtain a plurality of interconnected node comparison values;
identifying a candidate interconnected node pair of the plurality of interconnected node pairs according to the plurality of interconnected node comparison values; and
initiating a transfer of a pair of assets of the plurality of assets between the candidate interconnected node pair to obtain a recommended pair of assets, wherein a transfer of the recommended pair of assets facilitates lifecycle management of the plurality of assets.

18. The non-transitory, machine-readable medium of claim 17, wherein the plurality of asset utilization values are determined according to a multi-dimensional value.

19. The non-transitory, machine-readable medium of claim 18, wherein the multi-dimensional value comprises a combination of more than one of a travel time, a travel distance, a fuel consumption, an hourly drive rate, a road-surface condition, an asset run-time.

20. The non-transitory, machine-readable medium of claim 17, wherein the plurality of asset utilization values are determined according to a per event bases, the plurality of asset utilization values comprising one of miles traveled per event, or engine run-time per event, or a combination thereof.
